(19) United States
(12) Patent Application Publication
(10) Pub. No.: US 2024/0384568 A1
(43) Pub. Date: Nov. 21, 2024

(54) METHOD FOR EXPANDING THE FUNCTIONAL CAPABILITIES OF A DOOR LOCKING SYSTEM

(71) Applicant: Oleksandr KHARYBIN, Kharkiv (UA)

(72) Inventor: Oleksandr KHARYBIN, Kharkiv (UA)

(21) Appl. No.: 18/578,420

(22) PCT Filed: Oct. 12, 2021
(86) PCT No.: PCT/IB2021/059324

§ 371 Date: Jan. 11, 2024

(30) Foreign Application Priority Data
Jul. 23, 2021 (UA) A202104308

(51) Int. Cl. E05B 47/02; E05B 47/00

(52) U.S. Cl. CPC E05B 47/026; E05B 2047/0069

(57) ABSTRACT

The invention relates to systems for locking security structures.

The essence of the invention consists in that it operates on the basis of the movement of a blocked deadbolt to an extent at which it activates a position sensor, whereupon the deadbolt and the sensor are returned to a starting state, with said events occurring within a pre-programmed time limit.

The technical result of the invention is that of expanding the functional capabilities of a door locking system, with the addition of new functions for providing protection against the consequences of interference with an input device mounted on the outer side of the door.

The invention also permits the use of a standard lock key as an input device for performing a repeated series of actions according to the invention in order to generate a command to unblock the deadbolt of the lock.

The technical result of the invention is achieved without the structural modification of a door locking system and without the addition of any new devices and accessories.

### FIELD OF THE INVENTION

The present invention relates to locking systems of security structures such as doors (gates) of residential and office premises, garages, outdoor concession stands and the like, together with a lock mounted thereon and can be used to enhance the security properties of these locking systems and to improve their consumer qualities.

### DESCRIPTION OF THE PRIOR ART

In order to enhance security properties and improve the consumer qualities of locks, currently effective interstate standard GOST 5089-2011, “Locks, Latches, Cylinder Mechanisms—Specifications”, recommends to use additional functional devices, including alarm systems (see Note to Table 2 in Section 4.4.2 of this standard).

Devices that ensure an additional fixation (hereinafter called “blocking”) of the deadbolt of a completely closed lock hold a prominent place among these systems. The use of these devices improves significantly security properties of the so-called “lock+blocking device” locking systems because in all cases without exception increases their resistance to forceful lock picking methods and in case the blocking device has its own secret mechanism, to manipulation methods as well.

In their design, blocking devices can be either stand-alone or integrated into the lock case. The former have a number of important advantages, namely:
The possibility to work together with deadbolt locks of various designs, including those that have been in use for a long time.
No need to disassemble a lock to modify mechanisms of secrecy and deadbolt fixation. This excludes undesirable changes in the lock's operational characteristics.
The possibility to attach a lock deadbolt to the door frame, making it a rigid “door leaf
deadbolt—doorframe” coupler. This effectively prevents criminal forced entry (e.g. by pushing the door leaf away from the door frame).
The simplicity of a quick unblocking of the lock deadbolt manually from the inside. This is required in emergency situations, for example, such as a fire.
A significant simplification of the installation of wired communication lines of an electromechanical blocking device, if the latter is mounted on the door frame or in its cavity. For example, with such external devices necessary for its operation as an uninterruptible power supply (UPS) and an input device by means of which a command to unblock the deadbolt is generated.

An example of such stand-alone electromechanical blocking device intended for joint operation with mortise and surface-mounted locks of different designs is the “Lock Deadbolt Blocking Device” (patent UA 114136).

The main structural elements of the above device are a lock deadbolt position sensor, as well as an element blocking the lock deadbolt made in the form of a vertically movable rod, which is taken out of the recess in the deadbolt by electromagnet. The latter is actuated by an electronic control unit integrated into the blocking device upon receipt by the control unit a standart unblocking command from the input device.

A power frame for this blocking device is the sturdy electromagnet case made of magnetically soft steel. It reliably protects the electromagnet coil and the rod moved by it, both of which are placed therein, against criminal impact to a powerful electromagnet from the outside of the door.

The design of this blocking device ensures its operation in locking systems for both left-hand and right-hand doors, as well as the possibility of easy and quick manual unblocking of the deadbolt from inside the premise.

The use of electronic components from the lower price range, absence of miniature parts and strict requirements to the accuracy of their manufacture, as well as the use of advanced technological processes of their production (for example, making the electromagnet case from a standard metal profile by the laser cutting method) determine the relatively low cost of this blocking device.

And the presence of the deadbolt position sensor and the electromagnet control unit allows to expand the functional capabilities of the door locking system. In particular, it is possible to ensure continuous round-the-clock monitoring of the deadbolt position, as well as to start the unblocking process with a standart command from the input device.

An innovative “Alarm Device For A Door Provided With A Deadbolt Lock” (patent UA 112511) is an upgraded version of this known lock deadbolt blocking device. The design of the prior art blocking device was modified for the purpose to improve the reliability of holding the movable rod in the uppermost position in cases where deadbolt blocking is not required. A sensor that monitors the position of this rod was also added, which made it much easier to start the deadbolt blocking process. But, most importantly, in accordance with the recommendation of GOST 5089-2011 (see section 4.4.2) an electronic security alarm unit, which is placed on the same printed circuit board as the electromagnet control unit, was added to the prior art device for deadbolt blocking.

Inputs have also been added for connection of external actuating and input devices, such as sound and light sirens, push-button keypad, RFID- and DS-readers, security detector, as well as GSM-modem, which provides two-way communication of the blocking device with cell phones of ordinary users and the Main user (hereinafter—the administrator).

This modification significantly expands the functional capabilities of the stand-alone blocking device and, therefore, of the door locking system in which it is used. In particular, it has become possible to:
round-the-clock monitoring not only of the deadbolt position, but also of the door leaf on which the lock is mounted,
transmit immediate information about the current status of the door locking system via cellular network,
receive unblocking commands from users' cell phones, commands for setting operating parameters of the blocking device and for remote control of its operation from the administrator's cell phone.

The level of progress in modern electronics opens up great opportunities for further expanding of functional capabilities of door locking systems. Here, for example, is the point of view on this issue of such an authoritative specialist as the ex-president of the Ukrainian Locksmaster Federation Illya Voinov: Current trends in safety locking indicate that reliable classic mechanical systems remain relevant, but the challenges of the time are pushing to expand their capabilities through using electronics with their inherent monitoring and auditing capabilities. And this is not just another fashionable trend, it is the demands of the times and the recommendations of the best experts in the security industry. (Voinov I. “Modern master-key systems . . . ” http://www.bezpeka.spv.us/2016/08/cliq-vip.html).

An innovative AbloyProtec2 CLIQ electromechanical cylinder (see, for example, https://abloy.locksmith.com.ua/products/abloy-protec2-cliq/) is a convincing example of the successful realization of the capabilities of modern electronics in the creation of the latest locking systems. In addition to a high mechanical resistance to criminal burglary, it has an exclusively effective and flexible in control electronic access system, which is based on a revolutionary Protec CLIQ platform.

The unique functional capabilities of this cylinder is provided by a miniature blocking device integrated into its case in the form of a micromotor, which is controlled by a microelectronic control unit, as well as a key with its microelectronic contents. These cylinders can be used to create complex access control systems (ACSs) for facilities with numerous key-locked doors, each key providing selective program-defined access to dozens or even hundreds of premises.

Unfortunately, the Abloy Protec2 CLIQ is intended to equip only locks with cylinder secret mechanism and, moreover, its price much higher than most such locks. The latter is mostly due to a high labor intensity of the manufacture and assembly of miniature parts and components of both the cylinder itself and the keys to it.

In addition, it is not intended for continuous monitoring of the closed lock deadbolt, because its electronics is powered by a battery that is built directly into the key and, after removing the key from the cylinder becomes completely de-energized.

An example of a stand-along electromechanical device that not only reliably blocks the deadbolt of a closed lock, but also monitors small deadbolt displacements around the clock, is the “Lock-security” multifunctional device for deadbolt blocking, which has been created using the elemental base of modern electronics (Kharybin A. “It's high time to throw burglars idle!”//F+S: Security Technologies Nos. 5-6, 2018 https://www.haq.com.ua/tmp/5.eng.pdf).

This blocking device is an advanced variant of the security alarm device for a door provided with a deadbolt lock, wherein the GSM modem is placed directly on the printed circuit board of the blocking device, while the electromagnet control unit and the electronic security alarm unit are integrated into one sufficiently powerful and at the same time commercially available microcontroller.

A door locking system comprising a lock and the Lock-security multifunctional device intended to block its deadbolt, the latter is checked by the position sensor, which device takes a blocking element out of the deadbolt using an electromagnetic device, which is actuated by a unified control unit (hereinafter—CU) upon receipt by CU a standart unblocking command from an input device, which door locking system has a significantly wider functional capabilities than all currently known blocking systems of general (i.e. non special) applications including the above-mentioned analogues as well as the Abloy Protec2 CLIQ cylinder (see, for example, “Comparative capabilities of the newest locking systems”//https://www.haq.com.us/tmp/6 enq.pdf), and makes it possible to ensure:
The possibility of simultaneous operation with several of input devices of different types, which allows unblocking the deadbolt only after receiving standart commands from each of them. In this case, the security of the locking system, which comprises the “Lock-security” device and a lock with even the simplest secret mechanism, may be significantly higher than the secrecy of modern ATMs (see, for example, “Examples that demonstrate the capabilities of the “lock+Lock-security”locking system”//https://www.hag.com.ua/tmp/2.eng.pdf).
An automatic selection of the operation mode of the blocking device, when it is initialized, depending on the input devices connected to it.
Continuous monitoring of the completely closed lock deadbolt position, which makes it possible to quickly detect even a small displacement thereof and, if required, to generate an alarm notification as early as at the initial stage of unauthorized opening of the lock (this, in accordance with Section 6.2.5 of GOST 5089-2011, is the prerogative of early response locks).
Continuous monitoring of the door leaf against forceful burglary (for example, using a handheld power tool with an abrasive wheel) and the territory adjacent to the door from inside using a standard IR motion sensor connected to the blocking device and sending the alarm notification to the administrator's cell phone in the form of an SMS message.
The possibility of operation with a remote alarm button, with the help of which users may initiate both hidden from the burglar alarms (when an alarm SMS message “Urgent help needed” will be sent to the administrator's cell phone) and alarms with the additional activation of the siren for a time program-set by the administrator, which may attract the attention of surrounding people and scare away the burglar.
The possibility of round-the-clock display of the current state of the door locking system on a remote indicator, which is mounted on the outside of the door (for example, a LED integrated into the bell-button).
Rapid SMS-messaging to the administrator's cell phone about any non-routine events with the door locking system, which allows to automatically record these events with time reference in the memory of administrator's cell phone.
The possibility to duplicate each alarm SMS message with a call, which allows to immediately attract the attention of the administrator to it.
The possibility for administrator to record into the non-volatile memory of the CU numerous parameters that determine the operation of the blocking device and the door locking system as a whole, by sending the appropriate commands in the form of SMS messages to the blocking device previously switched (by a method inaccessible to unauthorized persons) to the programming mode. These parameters include, for example, the maximum time allowed for users to close the lock and blocking the deadbolt thereof (the so-called “exit delay”), as well as the maximum time for deadbolt unblocking and lock opening (the so-called “entrance delay”).
The possibility of operation with dozens of users' cell phones, which were previously entered by the administrator into the non-volatile memory of the CU microcontroller.
The possibility for the administrator to correct the list of user phone numbers.
The possibility for the administrator to repeatedly change the digital code of the standart unblocking command.
The possibility to send SMS replies to users' cell phones to their administrator-authorized inquiries about the current status of the locking system.
The possibility to control operation of relay output of the device by SMS- or DTMF-commands sent from the administrator's and users' phones, which allows remote turning on and off of external actuators connected to this output (e.g. an additional electromechanical lock).
The possibility to remotely allow or prohibit users to control the relay output operation by the administrator from his/her cell phone.
The possibility for the administrator to remotely change the mode of relay output operation (e.g. the duration of its operation).
The possibility of switching automatically to the unblocking mode from an external emergency power supply when the output voltage of the standard UPS drops below the threshold level value program-set by the administrator with sending him an SMS message about it.
The prohibition of any unauthorized unblocking of the deadbolt by the emergency power supply (if the regular UPS operates normally) with sending an alarm SMS message to the administrator's cell phone in case of each such attempt.
The automatic switch to emergency unblocking mode in case of loss of functionality of the input device or communication with it (i.e. when this device stops responding to periodic requests of the CU about its current status), for example, in case of problems with the GSM modem or cellular communication. In this operating mode, the deadbolt is unblocked by pressing and holding the emergency unblocking push-button hidden on the outside of the door for a program-set time.
Continuous monitoring of the IR motion sensor status with the ability of sending an alarm SMS message to the administrator's cell phone in case of its triggering.
The possibility of a remote activation or deactivation of the IR motion sensor by SMS- or DTMF-commands from the administrator's cell phone.
Continuous monitoring of the communication line between the IR motion sensor and the blocking device with sending an SMS message to the administrator's cell phone if the line is damaged.
The possibility for the administrator to remotely select the operation mode of the outside-mounted siren (e.g., a complete prohibition or changing its operation time).
Automatic correction of the real-time clock integrated into the CU according to periodic requests from the mobile operator about the current time.
Periodic checking of the account balance on the SIM-card installed in the GSM modem and sending an SMS message to the administrator when it drops below the value program-set by him.
Duplication an SMS message about the SIM-card account balance by a call in case of it drops below the critical level program-set by the administrator.

A high level of consumer qualities of the door locking system that comprises the “Lock-security” blocking device is due not only to the above-mentioned very helpful functional capabilities for its users, but also to the fact that this device is budget-friendly, which makes it even more attractive to them. So, for example, the price of this blocking device, if mass-produced, may be less than not only the current price of the Abloy Protec2 CLIQ cylinder but even the key to it. And the expected price of the entire door locking system highly resistant to both brute-force and manipulative methods of criminal burglary, which system comprises the “Lock-security” device and such a powerful lock as the ISEO D 61800280n01 (or the Cisa B lock), is comparable to the price of this cylinder today.

At the same time, the operation of a pilot batch of door locking systems with a multifunctional “Lock-security” blocking device, revealed two major disadvantages that may seriously limit their use, namely:

1. A physical accessibility of input devices mounted on the outside of the door (e.g., such as widely used RFID- and DS-readers, as well as push-button keypads) to criminal impact as opposed to their use in traditional security systems, where these input devices are mounted inside the secured premises, i.e., under the protection of the entrance door.
2. Significant reduction of the security properties of the door locking system in the emergency deadbolt unblocking mode when it is enough to press for some time the push-button hidden on the outside of the door. So, for example, if such a promising device, as a cell phone is used as an input device, an experienced burglar, if desired, can always find this push-button and successfully use it by provoking by local jamming of cellular communication forced switching of the “Lock-security” blocking device into emergency operation. At the same time the user, for whom the loss of functionality of the input device will most likely be a stressful surprise, can search for this hidden push-button for a long time, because normally he/she should use it very rarely.

### DETAILED DESCRIPTION

It is, therefore, the object of the present invention to eliminate both of the above-mentioned disadvantages by expanding the functional capabilities of the prior art door locking system that comprises a lock and the “Lock-security” blocking device without the structural modification of a door locking system and without the addition of any new devices and accessories.

This object is achieved by performing the sequence of actions in accordance with the present invention by a standard lock key, which ensures the movement of the blocked deadbolt until its position sensor is activated with further return of both to their starting state within a program-limited time.

The movement of the blocked deadbolt of a completely closed lock means such a displacement of the deadbolt relative to the blocking element (in this case, the rod), which is guaranteed to be detected by the deadbolt position sensor. This movement is only possible if the slot width or the recess diameter in the deadbolt is more than the thickness or diameter of the rod that blocks the deadbolt, respectively. The magnitude of such movement is determined by the difference of said geometric dimensions and should be as small as possible, but at the same time, ensure reliable activating of the deadbolt position sensor in case of its displacement and further return of the position sensor to the starting state after the deadbolt returns to the initial position (or close to it).

The optimum distance of such movement, which distance was determined during testing of door locking systems with prototypes of the “Lock-security” blocking device, in which systems a microswitch was used as a sensor of the deadbolt position, is in the range of 0.5-2 mm, but also may be different when using other sensors.

The limitation of the total time allotted for the movement of the deadbolt until its position sensor is activated with the further return of both to their starting state, complicates significantly criminal manipulations with the lock whose deadbolt is blocked by the blocking device. So, if this time exceeds a value program-set by the administrator, which value is kept in the non-volatile memory of the microcontroller of the CU, the latter will ignore such non-routine actions with the lock deadbolt and will wait for their repetition in accordance with the routine procedure. And in the event that the number of consecutively initiated non-routine actuations of the deadbolt position sensor exceeds the programmed value (e.g., 3 times), the CU will cease responding to any further actuations thereof for a program-set time (e.g., for several minutes). In such event, an alarm notification will be generated automatically with sending a “Key matching” SMS message to the administrator's cell phone and, if programmatically allowed, an outside-mounted siren will be turned on for a program-set time.

The optimum time for the limited movement and return of the deadbolt with the standard key, which time was determined during the process of testing a door locking systems with prototypes of the Lock-security blocking device, is within 1-2 sec.

The actions of the said method are easy to perform using the standard key, but they become extremely difficult in case of criminal manipulation of the lock (e.g., if using a lock-pick tool) because of a significant time limitation and the number of attempts to perform them.

The claimed invention is new, since no methods that comprise the aggregate of the above-specified material essential features of this invention are known for the state of the art.

In order to protect the door locking system from the consequences of an unauthorized impact on the input device, the latter is only activated for a program-set time, which starts counting down after the claimed sequence of actions has been completed. This time is set by the administrator taking into account ensuring comfortable work of users with a particular input device. Said unauthorized impact on the input device may be both accidental (e.g., an accidental pressing of the emergency unblock push-button hidden on the outside of the doors when this mode is activated by an outsider) and criminal (e.g., picking up the unblocking command code).

The activation of the input device depends on its design and is performed by the CU as follows:
by turning on the power supply, if operation of the input device in de-energized state is impossible (e.g., in the event of using a RFID-reader);
by activating the communication line between the CU and the power-free input device (e.g., a push-button).

In the event of no impact on the activated input device follows (e.g., if the RFID-card is still not presented to the reader mounted on the outer side of the door), the activation of this device can be repeated in the claimed way of the said invention as many times as program-set by the administrator (e.g., 4 times). After this, the CU will cease, for a long program-set time (e.g., for several minutes) responding to any actuations of the deadbolt position sensor and will generate an alarm notification with sending a “Key matching” SMS message to the administrator's cell phone.

And in the event that the activated input device is exposed to a non-routine impact (e.g., if unregistered by the administrator card is presented to the RFID-reader) the CU will immediately generate an alarm notification and send “Code picking” SMS message to the administrator's cell phone. In the event that the number of such consecutive attempts of activation with non-routine actions on the input device exceeds a program-set number thereof, the CU will cease reacting to any actuations of the deadbolt position sensor for a long program-set time (e.g., for several dozens of minutes) and therefore will not activate the input device entire time.

The standard lock key, by means of which a deadbolt unblocking command is generated, may be used as the input device, this makes it possible to reduce the cost of completing and mounting the door locking system. In this mode, unblocking command is generated by repeatedly repeating the actions of the said method at program-set intervals. The duration of these time intervals is determined by the number of marks in the packets, cut off by the claimed sequence of actions from the continuously following one after another marks, which the CU starts to generate after the first movement of the blocked deadbolt by the key until the sensor of its position is activated with further return of both to their starting state within a program-limited time. This makes it possible to generate a digital code for the deadbolt unblocking command, in which code each digit is equal to or a multiple of the number of marks in the corresponding packet. The CU ceases generating marks as soon as it detects that the user has stopped forming packets of marks.

The marks generated by the CU are displayed by means of an indicator mounted on the outside of the doors that is accessible to the user's sight, hearing, or finger, such as a LED, a buzzer, or a micro-vibrator. The choice of a specific type of said indicator and the place of its mounting are carried out taking into account the user's comfortable observation of it when generating a command code. At the same time, the possibility of an unauthorized observation of the indicator by outsiders in the process of digital code generation should be minimized. In this regard, it is worth noting that criminal tracking of marks will be almost impossible in case of using the micro-vibrator, which, moreover, allows even visually and hearing impairments users to work with it.

The generation of a deadbolt unblocking command with a key allows not only to reduce the cost of completing and mounting the door locking system, but also makes it practically impossible to unblock the deadbolt by any manipulative methods. The latter is quite possible if the user keeps a digital code of the standart unblocking command only in his/her memory rather than in any man-made device that can be substituted, remotely scanned, stolen or lost.

Thus, if the digital code of the standard unblocking command previously set by the administrator into the non-volatile memory of the CU microcontroller, contains, for instance, 12 decimal digits an intruder will need to go through up to a trillion code combinations in order to ensure unblock a deadbolt of the lock, with which the blocking device operates. In this case, the secrecy of even a door locking system that uses an ordinary latch instead of a lock, will be extremely high. For comparison: the secrecy of the best general-purpose locks usually does not exceed 10 million code combinations.

It should be noted that the generation of the command code for unblocking the deadbolt by the key has such disadvantages as a high loss probability of the digital code, if it is kept only in the user's memory and a relatively long time, which is necessary for the user to enter a multi-digital code.

The first of the above problems is easily solved, if the digital code is generated using simple, known only to the users, algorithms. For example, a complicated and almost unforgettable twelve-digit code for unblocking command can be composed of three four-digit numbers, each of which coincides, for example, with the year of birth of the mother, wife, or son of the user in forward or reverse order.

The second problem is caused only by the human physiological capabilities. For this very reason, for example, a real time, it took for different users to enter a twelve-digit code with a key when using the prototypes of the door locking system with the “Lock-security” blocking device, was in the range from 40 seconds to several minutes. This time can be significantly shortened by reducing the number of digits in the code or by generating the code from small packets of marks (i.e., using smaller digits). But at the same time, the resistance of the door locking system to intruder guessing the command code for unblocking the deadbolt will certainly reduced. Therefore, the administrator must assign a regular digital command code for unblocking, based on the level of responsibility of each particular door locking system: whether it is intended, for instance, for locking a safe, or for locking the door of an ordinary premises.

It should be noted that the use of the indicator to generate a code of any command is not a new engineering solution. For instance, in patent RU 2321713 entitled “Device For Entering Lock Actuator Access Code”, generation of an access code is accomplished by selection of symbols, which are sequentially displayed in a predetermined order with repeated repetition on the indicator of a special input means of control signal, which is included in the controller operation circuit of the lock actuating mechanism.

At the same time, the generation of a digital command code for unblocking the deadbolt with the standart key in accordance with the method of the present invention differs substantially from the conventional selection of symbols that the indicator sequentially displayed, and has the following advantages:
It is not necessary to additionally equip the lock with the deadbolt actuation mechanism.
It provides additional protection against any unauthorized generation of an unblocking command the level of which protection is determined by the secrecy of the lock with the standart key.
It becomes possible to use for the generation of a digital command code not only the digital indicator, but also a buzzer, a micro-vibrator or even an ordinary LED, which, for example, can be integrated into a bell-button.

In the event the CU detects the failure of the input device or loss communication with it, the command for emergency unblocking of the lock deadbolt is generated in the same way with the standart lock key. This makes criminal unblocking of the deadbolt when the emergency unblocking mode occurs much more difficult than using a secret push-button for this purpose. So, for example, if such an advanced device as a cell phone is used as the input device, the door locking system switches to the emergency unblocking mode of the deadbolt upon failure of the GSM modem integrated into the blocking device or loss of communication with it. Once these problems are eliminated, the door locking system automatically returns to the routine operation.

In order to improve the security properties of the door locking system when operating in emergency unblocking mode, the digital code of this command must be changed from time to time, just like the regular command code. And in order for the user can remember it, always and quickly, this code must either completely coincide with or be a fragment of the current digital code of the standart command. So, for example, as a command code for emergency unblocking of the deadbolt in the event of problems with the GSM modem, it is possible to assign, for example, the first two digits of the current unblocking command.

The above-mentioned aggregate of essential features of the present invention makes it possible to successfully achieve the object thereof, namely: to expand the functional capabilities of the door locking system with the addition of new functions, which ensure:
protection against the consequences of an unauthorized impact on the outdoor input device;
The possibility of using, as the input device, the standart lock key, by means of which digital command codes are generated for both regular and emergency lock deadbolt unblocking.

The technical result of the present invention is achieved without structural modification of a door locking system and without addition of any new devices and accessories.

No method is known from the state of the art, with the aid whereof the above-specified aggregate technical result is achieved due to using the essential features of the present invention. It may be, therefore, concluded that the present invention involves an inventive step.

The method of the present invention of expanding the functional capabilities of a door locking system was tested using prototypes of the “Lock-security” multifunctional device for blocking a lock deadbolt following their re-programming by the updated program. These tests confirmed the effectiveness of the said sequence of actions for the achievement of the above-specified technical result.

1. A method for expanding the functional capabilities of a door locking system, said system comprises a lock and a device for blocking a deadbolt, the latter is monitored by a position sensor, which device takes a blocking element out of the deadbolt using an electromagnetic device that is actuated by a control unit upon the latter receipt of a standard unblocking command from an input device, characterized in that, in order to expand the functional capabilities of the door locking system use of the movement of the blocked deadbolt until its position sensor is activated with a further return of both to their starting state within a program-limited time.

2. The method for expanding the functional capabilities of a door locking system as claimed in claim 1, characterized in that, in order to protect against the consequences of an unauthorized impact on the input device, the latter is only activated for the program-set time, which is counted down after the said sequence of actions has been performed.

3. The method for expanding the functional capabilities of a door locking system as claimed in claim 1, characterized in that, a standard lock key is used as the input device by means of which key a command to unblock the lock deadbolt is generated by repeated repetition of the said actions.

4. The method for expanding the functional capabilities of a door locking system as claimed in claim 3, characterized in that, upon detection by the control unit of failure of the input device or loss of communication with it, an emergency deadbolt unblocking command is generated using the standard lock key.
